(19) United States
(12) Patent Application Publication
(10) Pub. No.: US 2017/0183183 A1
(43) Pub. Date: Jun. 29, 2017

(54) RECORDING PAPER STORAGE DEVICE, ELECTRONIC APPARATUS AND ELECTRONIC REGISTER

(71) Applicant: CASIO COMPUTER CO., LTD., Tokyo (JP)

(72) Inventors: Takahiro NOZAKI, Tokyo (JP); Satoshi OGASAWARA, Tokyo (JP); Yoshihiko IWATA, Tokyo (JP)

(73) Assignee: CASIO COMPUTER CO., LTD., Tokyo (JP)

(21) Appl. No.: 15/251,389

(22) Filed: Aug. 30, 2016

(30) Foreign Application Priority Data
Dec. 25, 2015 (JP) 2015-252867

(51) Int. Cl. B65H 23/038; B65H 16/00; B65H 16/10; B41F 21/00

(52) U.S. Cl. CPC B65H 23/038; B41F 21/00; B65H 16/005; B65H 16/106; B65H 2701/19; B65H 2601/255

(57) ABSTRACT

A recording paper storage device of the present invention includes a recording paper storage section which stores recording paper wound in a roll shape, and a plurality of rollers which are arranged in a bottom portion of the recording paper storage section along an outer periphery of the recording paper wound in a roll shape and rotatably support the recording paper wound in a roll shape, in which at least one of the plurality of rollers is a movement regulation roller which regulates movement of the recording paper in a winding-off direction by winding-off of the recording paper wound in a roll shape in the recording paper storage section.

### CROSS-REFERENCE TO RELATED APPLICATION

This application is based upon and claims the benefit of priority from the prior Japanese Patent Application No, 2015-252867, filed Dec. 25, 2015, the entire contents of which are incorporated herein by reference.

### BACKGROUND OF THE INVENTION

1. Field of the Invention

The present invention relates to a recording paper storage device, an electronic apparatus and an electronic register.

2. Description of the Related Art

A recording paper storage device of a printer apparatus is known which has a structure including a recording paper storage section which stores recording paper wound in a roll shape and a plurality of rollers arranged in a bottom portion of the recording paper storage section along the outer periphery of the recording paper wound in a roll shape and rotatably support the recording paper wound in a roll shape , as disclosed in Japanese Patent Application Laid-Open (Kokai) Publication No. 2005-306535.

The recording paper storage device in this printer apparatus is structured such that, in order to print printing information on the recording paper wound in a roll shape by a printer section, the recording paper wound in a roll shape is rotated on the plurality of rollers arranged in the bottom portion of the recording paper storage section when it is fed into the printer section, and thereby fed into the printer section.

However, in the recording paper storage device in this printer apparatus, the recording paper wound in a roll shape is pulled to be moved toward the printer section when it is rotated on the plurality of rollers . Therefore, the recording paper wound in a roll shape comes in contact with an inner surface of the recording paper storage section located on the printer section side, and the frictional resistance of the recording paper occurs. Due to this frictional resistance, the recording paper wound in a roll shape cannot be smoothly fed.

### SUMMARY OF THE INVENTION

An object of the present invention is to enable recording paper wound in a roll shape to be smoothly fed.

In accordance with one aspect of the present invention, there is provided a recording paper storage device comprising: a recording paper storage section which stores recording paper wound in a roll shape and a plurality of rollers which are arranged in a bottom portion of the recording paper storage section along an outer periphery of the recording paper wound in a roll shape and rotatably support the recording paper wound in a roll shape, wherein at least one of the plurality of rollers is a movement regulation roller which regulates movement of the recording paper in a winding-off direction by winding-off of the recording paper wound in a roll shape in the recording paper storage section.

In accordance with another aspect of the present invention, there is provided an electronic apparatus comprising: a recording paper storage section which stores recording paper wound in a roll shape; a printer which is provided in an area that is near the recording paper storage section and located on a side to which the recording paper is fed, and prints information on the recording paper; and a plurality of rollers which are arranged in a bottom portion of the recording paper storage section along an outer periphery of the recording paper wound in a roll shape, and rotatably support the recording paper wound in a roll shape, wherein at least one of the plurality of rollers is a movement regulation roller which regulates movement of the recording paper in a winding-off direction by winding-off of the recording paper wound in a roll shape in the recording paper storage section.

In accordance with still another aspect of the present invention, there is provided an electronic register comprising: an input section which is used to input information regarding a commodity whose sales are registered; a recording paper storage section which stores recording paper wound in a roll shape; a printer which is provided in an area that is near the recording paper storage section and located on a side to which the recording paper is fed, and prints, on the recording paper, sales information based on the information regarding the commodity inputted by the input section; and a plurality of rollers which are arranged in a bottom portion of the recording paper storage section along an outer periphery of the recording paper wound in a roll shape, and rotatably support the recording paper wound in a roll shape, wherein at least one of the plurality of rollers is a movement regulation roller which regulates movement of the recording paper in a winding-off direction by winding-off of the recording paper wound in a roll shape in the recording paper storage section.

According to the present invention, the winding-off direction movement of recording paper wound in a roll shape when it is wound off from a recording paper storage section can be regulated. Accordingly, the recording paper wound in a roll shape is prevented from coming in contact with the recording paper storage section, whereby its frictional resistance with respect to the recording paper storage section can be significantly reduced. As a result, the recording paper wound in a roll shape can be smoothly fed.

The above and further objects and novel features of the present invention will more fully appear from the following detailed description when the same is read in conjunction with the accompanying drawings It is to be expressly understood, however, that the drawings are for the purpose of illustration only and are not intended as a definition of the limits of the invention.

### BRIEF DESCRIPTION OF THE DRAWINGS

FIG. 1 is a perspective view showing an embodiment in which the present invention has been applied in an electronic register;

FIG, 2 is an enlarged sectional view showing a printer unit serving as a printer apparatus of the electronic register when taken along line A-A in FIG. 1;

FIG. 3 is an enlarged plan view showing the inside of a recording paper storage section when a printer cover in the printer unit and a variable regulation section in an ejection regulation member are removed from the electronic register shown in FIG. 1; and

FIG. 4 is an enlarged sectional view showing the recording paper storage section taken along line B-B in FIG. 3.

### DETAILED DESCRIPTION OF THE PREFERRED EMBODIMENT

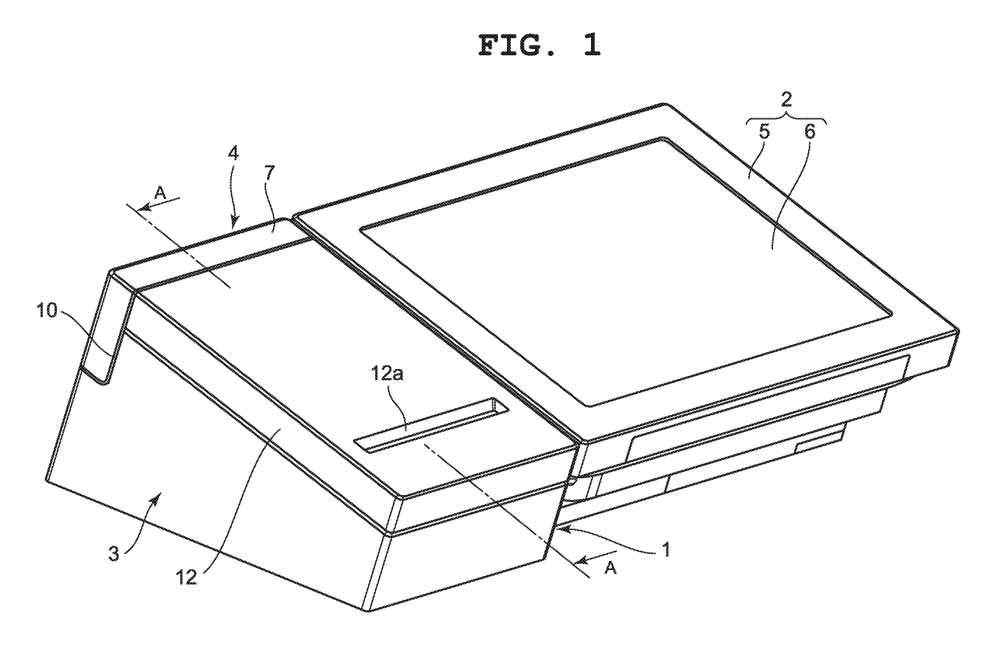

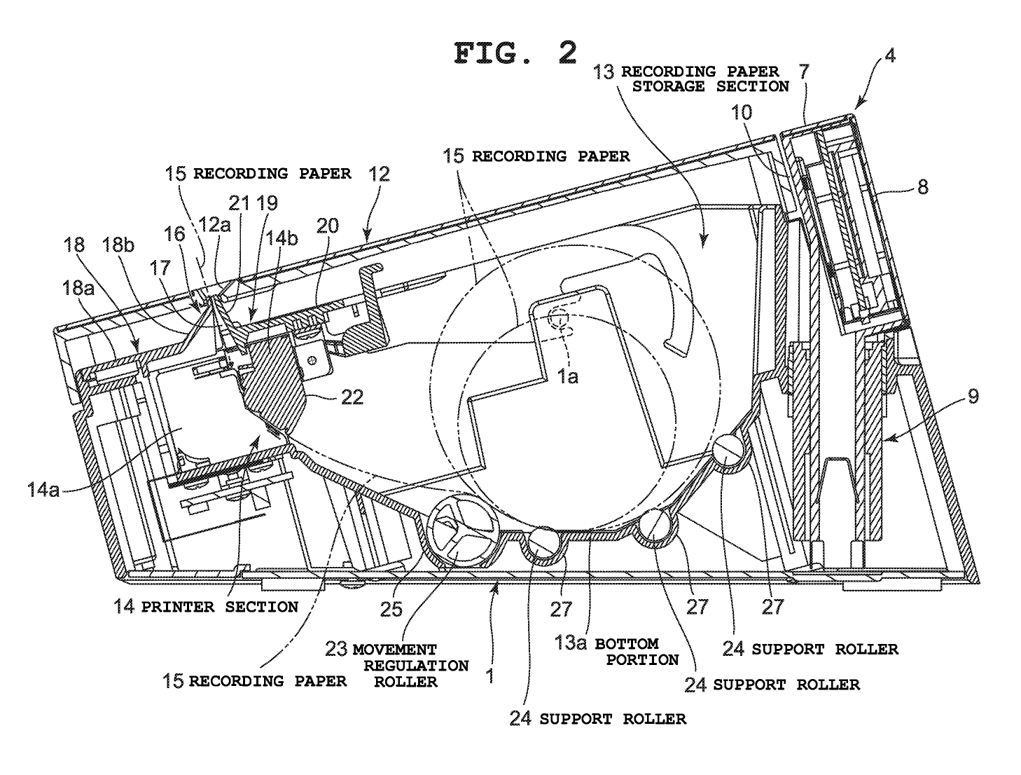

An embodiment in which the present invention has been applied in an electronic register will hereinafter be described with reference to FIG. 1 to FIG. 4

This electronic register includes a device case 1, as shown in FIG. 1. The device case 1 is loaded with an input display unit 2, a printer unit 3 serving as a printer apparatus, and an auxiliary display device 4.

The input display unit 2 includes a unit case 5 and an input display panel 6 provided on the upper surface of the unit case 5, and is structured such that an operator inputs information regarding a commodity which has been purchased by a customer and whose sales are registered using a touch operation of the input display panel 6, as shown in FIG. 1. The printer unit 3 prints sales information on recording paper, based on information regarding a commodity inputted by the input display unit 2, and issues a receipt

In this embodiment , the input display panel 6 has a structure where a transparent touch panel has been arranged on its upper surface, which is not shown.

The input display panel 6 is structured such that the operator performs a touch operation on the touch panel while viewing information displayed on the input display panel 6 so as to input information regarding a commodity whose sales are registered, and the input information regarding the commodity is displayed on the input display panel 6,

The printer unit 3 prints sales information based on commodity information inputted by the input display panel 6 on the recording paper.

The unit case 5 is arranged on the device case 1 with it being inclined forward and downward except for its one portion (a portion on the left side in FIG. 1)

In this embodiment y a rotating portion (not shown) projecting into a semi-cylindrical shape is provided on the lower surface of the unit case 5, and a support portion (not shown) recessed into a semi-cylindrical shape in which the rotating portion in the unit case 5 is rotatably arranged is provided on the device case 1,

As a result, the unit case 5 is structured such that its rear portion (on the side of its upper side in FIG. 1) rises to be inclined when the semi-cylindrical-shaped rotating portion on the lower surface rotates and moves in the semi-cylindrical-shaped support portion on the device case 1.

The auxiliary display device 4 is structured by a display case 7 including a display section 8 that displays information. The display case 7 is supported on a stretchable support section 9 such that it is rotatable in a horizontal direction, and is retractably arranged in a display storage section 10 provided on the back surface of the device case 1 by the support section 9, as shown in FIG. 1 and FIG. 2.

More specifically, the auxiliary display device 4 is structured such that the support section 9 is extended upward so that the display case 7 is pulled up from inside the display storage section 10 in the device case 1 and arranged above the device case 1, and then the display case 7 is rotated in a substantially horizontal direction around the support section 9 in this state so that information displayed on the display section 8 can be easily viewed from a customer, as shown in FIG. 1 and FIG. 2.

On the other hand, the printer unit 3 serving as a printer apparatus includes a printer cover 12 openably arranged on the device case 1, a recording paper storage section 13 provided inside the device case 1, and a printer section 14 arranged in the vicinity of the recording paper storage section 13 in the device case 1, and is arranged in the device case 1 in a manner to be located on the left side of the input display unit 2, as shown in FIG. 1 and FIG. 2.

The printer cover 12 is attached to the device case 1 such that it is openable and closable toward the left side of the device case 1, i.e., the side opposite to the input display unit 2 at substantially the same height as the upper surface of the input display unit 2 with it being inclined forward and downward, as shown in FIG. 1 and FIG. 2.

The recording paper storage section 13, which stores recording paper 15 wound in a roll shape, is formed into a substantially semi-cylindrical concave shape toward the front side (the left side in FIG. 2) from the rear side (the right side in FIG, 2) of the device case 1.

The printer section 14 includes a print head 14a and a platen 14b, and is arranged on the front side (the left side in FIG, 2) of the recording paper storage section 13 in the device case 1, as shown in FIG. 2.

More specifically, the print head 14a is arranged in an outer upper portion on the front side of the recording paper storage section 13, and the platen 14b is arranged in an inner upper portion on the front side of the recording paper storage section 13 such that it corresponds to the printing head 14a.

As a result, the printer section 14 is structured such that the recording paper 15 wound in a roll shape and stored in the recording paper storage section 13 is fed into an area between the print head 14a and the platen 14h, the print head 14a prints printing information on the fed recording paper 15, and the printed recording paper 15 is fed toward a recording paper ejection port 12a in the printer cover 12, as shown in FIG. 2.

In this embodiment, the recording paper ejection port 12a in the printer cover 12 is formed into a long narrow rectangular shape and located on the front side of the printer cover 12 in the direction perpendicular to the longitudinal direction of the printer cover 12 such that it corresponds to an area between the printing head 14a and the platen 14b when the printer cover 12 is arranged on the device case 1 and closed, as shown in FIG. 1 and FIG. 2.

Also, in an area between the printer section 14 and the printer cover 12, an ejection regulation member 16 is provided, as shown in FIG. 2.

The ejection regulation member 16 includes a regulation path 17, and has a structure where the regulation path 17 regulates the position of the recording paper 15 such that a leading edge of the recording paper 15 printed by the printer section 14 on the ejection side is pinched in the thickness direction of the recording paper 15, and feeds the recording paper 15 into a recording paper ejection port 12a in the printer cover 12.

More specifically, the ejection regulation member 16 is structured such that its tapered upper end on the printer cover 12 side is inserted into a lower portion of the recording paper ejection port 12a in the printer cover 12 when the printer cover 12 is arranged on the device case 1 and closed by covering the recording paper storage section 13 and the printer section 14, as shown in FIG. 2.

Also, the ejection regulation member 16 includes a fixing regulation section 18 fixed to the device case 1 for covering the print head 14a in the printer section 14 and a movable regulation section 19 provided in a manner to be movable in an ejection direction of the recording paper 15 with respect to the device case 1 so as to hold the platen 14b in the printer section 14, as shown in FIG. 2.

The fixed regulation section 18 includes a fixing section 18a fixed to an upper portion on the front side of the device case 1 and a first guide inclination portion 18b inclined toward the recording paper ejection port 12a in the printer cover 12 from the fixing section 18a, as shown in FIG. 2.

The fixing section 18a is formed in a substantially flat plate shape, attached on the device case 1, and positioned on the upper side of the print head 14a.

The movable regulation section 19 includes a rotary support section 20 attached in the device case 1 on the platen 14b side in a manner to be rotatable in a vertical direction, a second guide inclination section 21 inclined toward the recording paper ejection port 12a in the printer cover 12 from the rotary support section 20, and a platen attachment section 22 provided in the rotary support section 20 such that the platen 14b is attached thereto, as shown in FIG. 2.

In this embodiment, the rotary support section 20 is rotatably attached to support shafts 1a respectively provided on inner surfaces on both sides of the device case 1.

As a result, the movable regulation section 19 is structured such that the rotary support section 20 rotates in a vertical direction around the support shafts 1a in the device case 1, as shown in FIG. 2.

More specifically, the movable regulation section 19 is structured such that the rotary support section 20 is arranged in an upper portion on the front side of the recording paper storage section 13 when it is rotated in the counterclockwise direction around the support shafts 1a in the device case 1.

In this embodiment, the movable regulation section 19 is structured such that, when the rotary support section 20 is arranged in the upper portion on the front side of the recording paper storage section 13, the second guide inclination section 21 provided in the rotary support section 20 is arranged corresponding to the first guide inclination section 18b in the fixing regulation section 18, whereby the regulation path 17 in the election regulation member 16 is formed, and the platen 14b attached to the platen attachment section 22 is arranged corresponding to the print head 14a, as shown in FIG. 2.

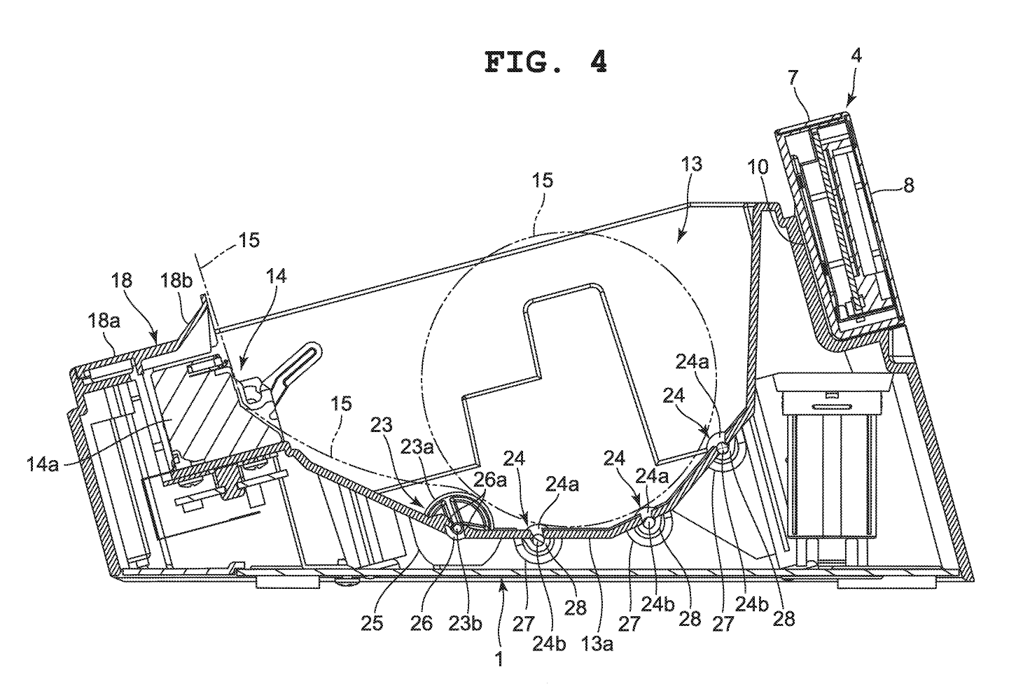

In a bottom portion 13a in the recording paper storage section 13 in the printer unit 3, a plurality of rollers 23 and 24 which rotatably support the recording paper 15 wound in a roll shape are arranged along the outer periphery of the recording paper 15 wound in a roll shape, as shown in FIG, 2 to FIG. 4.

The plurality of rollers 23 and 24 include a movement regulation roller 23 which regulates the movement of the recording paper 15 in a winding-off direction when this recording paper 15 wound in a roll shape is wound off in the recording paper storage section 13, and a plurality of support rollers 24 which rotatably support the recording paper 15 wound in a roll shape.

In this embodiment , the movement regulation roller 23 is arranged closest to the printer section 14 to which the recording paper 15 wound in a roll shape is fed from the recording paper storage section 13 and information is printed thereon, as shown in FIG. 2 to FIG. 4.

More specifically, the movement regulation roller 23 is arranged on the front side in the bottom portion 13a in the recording paper storage section 13.

Also, the plurality of support rollers 24 are sequentially arranged at predetermined intervals toward the rear side of the recording paper storage section 13 from the rear side of the movement regulation roller 23 in the bottom portion 13a in the recording paper storage section 13.

As a result, the movement regulation roller 23 and the plurality of support rollers 24 are structured to rotatably support the recording paper 15 wound in a roll shape with the lower side of the recording paper 15 wound in a roll shape being wrapped, as shown in FIG. 2 to FIG. 4.

In this embodiment, the movement regulation roller 23 includes a regulation roller section 23a and regulation roller shafts 23b provided on both sides of the regulation roller section 23a.

Each of the plurality of support rollers 24 includes a support roller section 24a and support roller shafts 24bprovided on both sides of the support roller section 24a.

In this embodiment, the movement regulation roller 23 is formed such that the outer diameter of the regulation roller section 23a is larger than the outer diameter of each of the support roller sections 24a in the plurality of support rollers 24, as shown in FIG. 2 to FIG. 4.

As a result , the movement regulation roller 23 is structured such that, when the recording paper 15 wound in a roll shape comes in contact with the regulation roller section 23a, the contact area of the recording paper 15 wound in a roll shape on the regulation roller section 23a increases, and the contact force of the recording paper 15 wound in a roll shape with respect to the regulation roller section 23a is dispersed to reduce the frictional resistance of the recording paper 15,

Also, the movement regulation roller 23 is formed such that the projection length of the regulation roller section 23a projecting into the recording paper storage section 13 from the bottom portion 13a in the recording paper storage section 13 is larger than the projection length of each of the support roller sections 24a of the plurality of support rollers 24 projecting into the recording paper storage section 13 from the bottom portion 13a in the recording paper storage section 13, as shown in FIG. 2 to FIG. 4.

Accordingly, in the bottom portion 13a in the recording paper storage section 13, a regulation roller storage section 25 having a substantially semi-circular arc concave shape, which rotatably stores the regulation roller section 23a, is provided on the front side of the recording paper storage section 13 located closest to the printer section 14 with the upper side of the regulation roller section 23a in the movement regulation roller 23 projecting into the recording paper storage section 13, as shown in FIG. 2 to FIG. 4

Also, regulation shaft holding sections 26 having a substantially semi-circular arc concave shape, which respectively rotatably hold the regulation roller shafts 23b in the regulation roller 23, are provided on both sides of the regulation roller storage section 25 in the bottom portion 13a in the recording paper storage section 13, i.e., on both sides in the direction perpendicular to the longitudinal direction of the recording paper storage section 13, as shown in FIG. 2 to FIG, 4.

In this embodiment , the regulation shaft holding section 26 having a substantially semi-circular arc concave shape is structured to include a locking protrusion 26a provided in its opening so that the regulation roller shaft 23b does not unnecessarily come off the regulation shaft holding section 26.

Also, in the bottom portion 13a in the recording paper storage section 13, a plurality of support roller storage sections 27 having a substantially semi-circular arc concave shape, which respectively rotatably store the support roller sections 24a, are provided at predetermined intervals from the rear side of the regulation roller storage section 25 to the rear side of the recording paper storage section 13 along the curvature of the circular arc shape of the bottom portion 13a in the recording paper storage section 13 with the upper side of each of the support roller sections 24a in the plurality of support rollers 24 projecting into the recording paper storage section 13, as shown in FIG. 2 to FIG. 4.

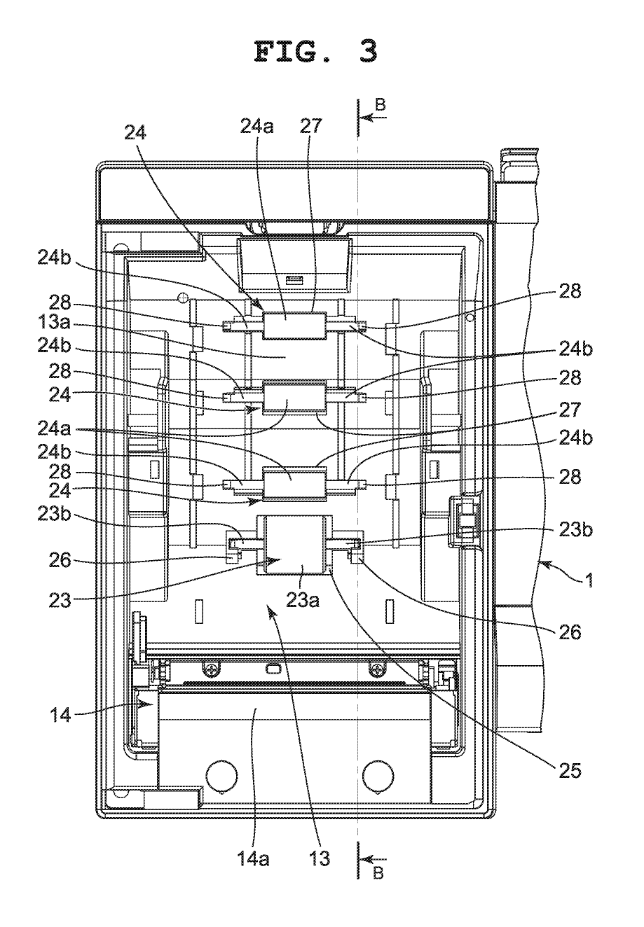

Also, a plurality of support shaft holding sections 28 having a substantially semi-circular arc concave shape, which respectively rotatably hold the support roller shafts 24b in the plurality of support rollers 24, are respectively provided on both sides of the plurality of support roller storage sections 27 in the bottom portion 13a of the recording paper storage section 13, i.e., on both sides in the direction perpendicular to the longitudinal direction of the recording paper storage section 13, as shown in FIG. 3 and FIG. 4.

The plurality of support shaft holding sections 28 are respectively structured such that, by their respective openings being constricted, the support roller shafts 24b do not unnecessarily come off the support shaft holding sections 28.

In this embodiment, the regulation shaft holding section 26 and the plurality of support shaft holding sections 28 are formed such that respective distances from the upper surface of the bottom portion 13a in the recording paper storage section 13 to the respective centers of inner portions of the regulation shaft holding section 26 and the plurality of support shaft holding sections 28 are the same to make the projection length of the regulation roller section 23a projecting into the recording paper storage section 13 from the bottom portion 13a in the recording paper storage section 13 in the movement regulation roller 23 larger than the projection length of each of the support roller sections 24a of the plurality of support rollers 24 projecting into the recording paper storage section 13 from the bottom portion 13a in the recording paper storage section 13, as shown in FIG. 4.

As a result, the recording paper storage section 13 is structured such that, when the recording paper 15 wound in a roll shape and stored in the inner portion thereof is to be fed to the printer section 14, it is moved toward the movement regulation roller 23 while rotating on each of the support roller sections 24a in the plurality of support rollers 24, and comes in contact with the regulation roller section 23a in the movement regulation roller 23, as shown in FIG. 2 to FIG, 4.

As a result, the recording paper storage section 13 is structured such that, by the recording paper 15 wound in a roll shape coming in contact with the regulation roller section 23a in the movement regulation roller 23, the movement of the recording paper 15 in the winding-off direction by the winding-off of the recording paper 15 is regulated by the regulation roller section 23a of the movement regulation roller 23, and the recording paper 15 wound in a roll shape is fed to the printer section 14 while the movement regulation roller 23 is rotating in this state, as shown in FIG. 2 to FIG. 4.

Next, the mechanism of the electronic apparatus is described.

When the electronic apparatus Is to be used, first, the inclination of the unit case 5 in the input display unit 2 to the device case 1 is adjusted and the height and the direction of the auxiliary display device 4 are adjusted.

More specifically, in the adjustment of the inclination of the unit case 5, the rotation portion having the semi-cylindrical shape on the lower surface of the unit case 5 is moved and rotated in the support portion having the semi-cylindrical shape on the device case 1 so as to adjust the rise of the rear portion (on the side of the upper side in FIG. 1) of the unit case 5 and incline the input display panel 6 in the input display unit 2 to an angle at which the operator can easily perform a touch operation.

Also, in the adjustment of the height and the direction of the auxiliary display device 4, the support section 9 in the auxiliary display section 4 is extended upward so as to pull up the display case 7 in the auxiliary display device 4 from inside the display storage section 10 in the device case 1 and arrange the display case 7 above the device case 1, and the display case 7 is rotated in a substantially horizontal direction around the support section 9 in this state. As a result, information displayed on the display section 8 is oriented at a height and in a direction in which it can be easily viewed by a customer.

In this state, when the operator performs a touch operation on the input display panel 6 in the input display unit 2 so as to input information regarding a commodity to be bought or sold, the inputted information is displayed on the input display panel 6 of the input display unit 2 and the display section 8 in the auxiliary display device 4.

As a result, the information displayed on the input display panel 6 in the input display unit 2 can be viewed by the operator and the information displayed on the display section 8 in the auxiliary display device 4 can be viewed by the customer.

When the information displayed as described above is to be printed as sales data by the printer unit 3 so as to issue a receipt, the operator performs a touch operation on the input display panel 6 in the input display unit 2 so as to drive the printer section 14 in the printer unit 3

As a result, the print head 14a in the printer section 14 sequentially prints the sales data on the recording paper 15, and issues printed recording paper 15 as a receipt.

In this embodiment, the recording paper 15 wound in a roll shape is stored in advance in the recording paper storage section 13 in the device case 1.

Here, the printer cover 12 is opened to expose the recording paper storage section 13 and the movable regulation section 19 in the ejection regulation member 16 provided in the device case 1 is rotated to move the platen 14b in the printer section 14 to an area above the device case 1.

In this state, the recording paper 15 wound in a roll shape is stored in the recording paper storage section 13 in the device case 1, and its leading edge is pulled and arranged corresponding to the print head 14a in the printer section 14.

Then, the movable regulation section 19 in the ejection regulation member 16 is rotated and arranged in an upper portion of the recording paper storage section 13.

As a result, the rotary support section 20 in the movable regulation section 19 rotates in the counterclockwise direction around the support shafts 1a in the device case I, and is arranged in an upper portion of the recording paper storage section 13 on the front side.

Here, the second guide inclination section 21 in the movable regulation section 19 in the ejection regulation member 16 forms the regulation path 17 in the ejection regulation member 16 such that it corresponds to the first guide inclination section 18b in the fixing regulation section 18.

Also, here, the platen 14b provided in the platen attachment section 22 in the movable regulation section 19 is arranged corresponding to the print head 14a, and the recording paper 15 fed from the recording paper storage section 13 is pinched between the platen 14b and the print head 14a. As a result, the electronic device enters a state where the printer section 14 can print printing information on the recording paper 15.

In this state, when the printer cover 12 is rotated, arranged on the device case 1, and closed, the recording paper ejection port 12a provided in the printer cover 12 corresponds to an area between the print head 14a and the platen 14b in the printer section 14 and the tapered upper end of the ejection regulation member 16, i.e., each of opposite upper ends of the first guide inclination section 18b in the fixing regulation section 18 and the second guide inclination section 21 in the movable regulation section 19 is inserted into a lower portion of the recording paper ejection port 12a in the printer cover 12.

When the print head 14a in the printer section 14 is driven in this state, the print head 14a sequentially prints printing information on the recording paper 15 fed from the recording paper storage section 13 while pressing the recording paper 15 against the platen 14b.

This printed recording paper 15 is ejected out of the device case 1 from the recording paper ejection port 12a in the printer cover 12 via the regulation path 17 in the ejection regulation member 16.

In this embodiment, when the printer section 14 is sequentially printing information on the recording paper 15, the recording paper 15 wound in a roll shape is sequentially fed from the recording paper storage section 13. That is, the recording paper 15 wound in a roll shape is sequentially fed to the printer section 14 while rotating on the movement regulation roller 23 and the plurality of support rollers 24 in the recording paper storage section 13.

Here, the recording paper 15 wound in a roll shape is drawn toward the printer section 14. Accordingly, the recording paper 15 wound in a roll shape moves on the plurality of support rollers 24 toward the printer section 14, and comes in contact with the regulation roller section 23a in the movement regulation roller 23.

As a result, the movement regulation roller 23 regulates the movement of the recording paper 15 in the winding-off direction caused by the winding-off of the recording paper 15, and feeds the recording paper 15 to the printer section 14 while rotating in this state.

More specifically, the movement regulation roller 23 is arranged at a position close to the printer section 14 in the bottom portion 13a of the recording paper storage section 13. This movement regulation roller 23 has been formed such that the outer diameter of the regulation roller section 23a is larger than the outer diameter of each of the support roller sections 24a in the plurality of support rollers 24 and the upper side of the regulation roller section 23a more greatly projects from the bottom portion 13a of the recording paper storage section 13 into the recording paper storage section 13 than the upper side of each of the plurality of support roller sections 24a.

Therefore, when the recording paper 15 drawn toward the printer section 14 moves toward the movement regulation roller 23, this recording paper 15 wound in a roll shape reliably comes in contact with the regulation roller section 23a in the movement regulation roller 23.

As a result, the regulation roller section 23a in the movement regulation roller 23 favorably regulates the movement of the recording paper 15 in the winding-off direction caused by the winding-off of the recording paper 15.

Also, when the recording paper 15 wound in a roll shape thus comes in contact with the regulation roller section 23a in the movement regulation roller 23, the contact area of the recording paper 15 wound in a roll shape on the regulation roller section 23a increases because the outer diameter of the regulation roller section 23a is larger than the outer diameter of each of the support roller sections 24a in the plurality of support rollers 24. Therefore, the contact force of the recording paper 15 wound in a roll shape on the regulation roller section 23a is dispersed, so that the frictional resistance of the recording paper 15 is reduced.

In this embodiment, when the outer diameter of the recording paper 15 wound in a roll shape is large, this recording paper 15 wound in a roll shape is supported by almost all of the movement regulation roller 23 and the plurality of support rollers 24. Accordingly, when the recording paper 15 wound in a roll shape is to be fed to the printer section 14, it hardly moves toward the printer section 14 side, but comes in contact with the movement regulation roller 23, so that its movement in the winding-off direction caused by it being wound off is regulated.

Also, when the outer diameter of the recording paper 15 wound in a roll shape is decreased, it is supported by the movement regulation roller 23 and one of the support rollers 24 positioned on the side to which the recording paper 15 is fed. Accordingly, when being fed to the printer section 14, the recording paper 15 having a small outer diameter greatly moves toward the printer section 14, and then comes in contact with the movement regulation roller 23. As a result, the movement of the recording paper 15 in the winding-off direction by the winding-off of the recording paper 15 is regulated by the movement regulation roller 23.

When the recording paper 15 wound in a roll shape is to be fed to the printer section 14 with it being in contact with the movement regulation roller 23 and its movement in the winding-off direction by winding-off being regulated, the movement regulation roller 23 feeds it to the printer section 14 while rotating.

Thus, even though the recording paper 15 wound in a roll shape comes in contact with the movement regulation roller 23, the frictional resistance of the recording paper 15 hardly occurs.

As a result of this structure, the recording paper 15 can be smoothly fed to the printer section 14. Therefore, no sheet jam occurs.

As described above, the printer unit 3 serving as the printer apparatus of the electronic register includes the recording paper storage section 13 which stores the recording paper 15 wound in a roll shape, and the plurality of rollers 23 and 24 which are arranged along the outer periphery of the recording paper 15 wound in a roll shape in the bottom portion 13a of the recording paper storage section 13 and rotatably support the recording paper 15 wound in a roll shape. In addition, the plurality of rollers 23 and 24 include the movement regulation roller 23 which regulates the movement of the recording paper 15 in the winding-off direction by the winding-off of the recording paper 15 in the recording paper storage section 13 and the plurality of support rollers 24 which rotatably support the recording paper 15 wound in a roll shape Therefore, the printer unit 3 can smoothly feed the recording paper 15 wound in a roll shape.

More specifically, in the printer unit 3 serving as the printer apparatus, even when the recording paper 15 wound in a roll shape and stored in the recording paper storage section 13 is moved in the feeding direction so as to be fed, the movement of the recording paper 15 in the winding-off direction by the winding-off of the recording paper 15 can be regulated by the movement regulation roller 23.

Accordingly, the recording paper 15 wound in a roll shape is prevented from coming in contact with the recording paper storage section 13, whereby the frictional resistance of the recording paper 15 on the recording paper storage section 13 can be significantly reduced. Therefore, the recording paper 15 wound in a roll shape can be smoothly fed. As a result, no sheet jam can occurs.

In this embodiment, the movement regulation roller 23 is arranged closest to the side to which the recording paper 15 wound in a roll shape is fed. Therefore, when the recording paper 15 wound in a roll shape is to be fed from the recording paper storage section 13, it comes in contact with the movement regulation roller 23 although it is moved toward the printer section 14 side which is the side where it is fed, whereby the movement of the recording paper 15 in the winding-off direction by the winding-off of the recording paper 15 can be reliably regulated by the movement regulation roller 23.

Also, the movement regulation roller 23 is formed such that its outer diameter is larger than the outer diameter of each of the plurality of support rollers 24. Therefore, when the recording paper 15 wound in a roll shape is to be fed from the recording paper storage section 13, it reliably comes in contact with the movement regulation roller 23 although it is moved toward the printer section 14 side which is the side to which it is fed, whereby the movement of the recording paper 15 in the winding-off direction by the winding-off of the recording paper 15 is reliably and favorably regulated by the movement regulation roller 23.

In this embodiment, the outer diameter of the movement regulation roller 23 is larger than the outer diameter of each of the plurality of support rollers 24. Therefore, the contact area of the recording paper 15 with respect to the movement regulation roller 23 when the recording paper 15 wound in a roll shape comes in contact with the movement regulation roller 23 is large.

Accordingly, the contact force of the recording paper 15 on the movement regulation roller 23 is dispersed, whereby the frictional resistance of the recording paper 15 with respect to the movement regulation roller 23 is reduced.

Moreover, the movement regulation roller 23 is formed such that the projection length of the movement regulation roller 23 projecting into the recording paper storage section 13 from the bottom portion 13a of the recording paper storage section 13 is larger than the projection length of each of the plurality of support rollers 24 projecting into the recording paper storage section 13 from the bottom portion 13a of the recording paper storage section 13. Therefore, the recording paper 15 wound in a roll shape can reliably come in contact with the movement regulation roller 23 when it is fed from the recording paper storage section 13.

More specifically, the movement regulation roller 23 is formed such that, when the recording paper 15 wound in a roll shape is to be fed from the recording paper storage section 13, it reliably comes in contact with the movement regulation roller 23 although it is moved toward the printer section 14 side that is the side to which it is fed, whereby the movement of the recording paper 15 in the winding-off direction by the winding-off of the recording paper 15 can be reliably and favorably regulated by the movement regulation roller 23.

As described above, the movement regulation roller 23 in the printer unit 3 is arranged at a position closest to the printer section 14, in the bottom portion 13a of the recording paper storage section 13. This movement regulation roller 23 is formed such that the outer diameter thereof is larger than the outer diameter of each of the support rollers 24 and the upper side of the movement regulation roller 23 more greatly projects into the recording paper storage section 13 from the bottom portion 13a of the recording paper storage section 13 than the upper side of each of the plurality of support rollers 24. Therefore, the recording paper 15 wound in a roll shape, which has been drawn toward the printer section 14 side, reliably comes in contact with the movement regulation roller 23, so that the movement of the recording paper 15 in the winding-off direction by the winding-off of the recording paper 15 can be favorably regulated.

Thus, when the recording paper 15 wound in a roll shape is to be fed to the printer section 14 with it being in contact with the movement regulation roller 23 and its movement in the winding-off direction by winding-off being regulated, the movement regulation roller 23 can feed the recording paper 15 to the printer section 14 while rotating.

As a result, although the recording paper 15 wound in a roll shape comes in contact with the movement regulation roller 23 and the movement regulation roller 23 unfailingly regulates the movement of the recording paper 15 in the winding-off direction by the winding-off of the recording paper 15, since the movement regulation roller 23 feeds the recording paper 15 to the printer section 14 while rotating, the frictional resistance of the recording paper 15 hardly occurs between the recording paper 15 wound in a roll shape and the movement regulation roller 23, and the recording paper 15 can be smoothly fed to the printer section 14. Accordingly, no sheet jam occurs.

In the above-described embodiment, the present invention has been applied in an electronic register. However, the present invention is not necessarily required to be applied in an electronic register. For example , the present invention can be widely applied in an electronic apparatus such as a facsimile including a printer apparatus or a portable information processing apparatus including a printer apparatus.

While the present invention has been described with reference to the preferred embodiments, it is intended that the invention be not limited by any of the details of the description therein but includes all the embodiments which fall within the scope of the appended claims.

What is claimed is:

1. A recording paper storage device comprising:
a recording paper storage section which stores recording paper wound in a roll shape; and
a plurality of rollers which are arranged in a bottom portion of the recording paper storage section along an outer periphery of the recording paper wound in a roll shape and rotatably support the recording paper wound in a roll shape,
wherein at least one of the plurality of rollers is a movement regulation roller which regulates movement of the recording paper in a winding-off direction by winding-off of the recording paper wound in a roll shape in the recording paper storage section.

2. The recording paper storage device according to claim 1, wherein the movement regulation roller is arranged closest to a side to which the recording paper wound in a roll shape is fed.

3. The recording paper storage device according to claim 1, wherein the movement regulation roller is formed such that an outer diameter thereof is larger than an outer diameter of each of the plurality of rollers excluding the movement regulation roller.

4. The recording paper storage device according to claim 1, wherein the movement regulation roller is formed such that a projection length of the movement regulation roller projecting into the recording paper storage section from the bottom portion of the recording paper storage section is larger than a projection length of each of the plurality of rollers other than the movement regulation roller which are projecting into the recording paper storage section from the bottom portion of the recording paper storage section.

5. The recording paper storage device according to claim 1, wherein a printer which prints information on the fed recording paper is arranged in an area that is near the recording paper storage section and located on a side to which the recording paper wound in a roll shape is fed.

6. An electronic apparatus comprising the recording paper storage device according to claim 1.

7. An electronic apparatus comprising
a recording paper storage section which stores recording paper wound in a roll shape;
a printer which is provided in an area that is near the recording paper storage section and located on a side to which the recording paper is fed, and prints information on the recording paper; and
a plurality of rollers which are arranged in a bottom portion of the recording paper storage section along an outer periphery of the recording paper wound in a roll shape, and rotatably support the recording paper wound in a roll shape,
wherein at least one of the plurality of rollers is a movement regulation roller which regulates movement of the recording paper in a winding-off direction by winding-off of the recording paper wound in a roll shape in the recording paper storage section.

8. The electronic apparatus according to claim 7, wherein the movement regulation roller is arranged closest to a side to which the recording paper wound in a roll shape is fed.

9. The electronic apparatus according to claim 7, wherein the movement regulation roller is formed such that an outer diameter thereof is larger than an outer diameter of each of the plurality of rollers excluding the movement regulation roller.

10. The electronic apparatus according to claim 7, wherein the movement regulation roller is formed such that a projection length of the movement regulation roller projecting into the recording paper storage section from the bottom portion of the recording paper storage section is larger than a projection length of each of the plurality of rollers other than the movement regulation roller which are projecting into the recording paper storage section from the bottom portion of the recording paper storage section.

11. An electronic register comprising:
an input section which is used to input information regarding a commodity whose sales are registered;
a recording paper storage section which stores recording paper wound in a roll shape;
a printer which is provided in an area that is near the recording paper storage section and located on a side to which the recording paper is fed, and prints, on the recording paper, sales information based on the information regarding the commodity inputted by the input section; and
a plurality of rollers which are arranged in a bottom portion of the recording paper storage section along an outer periphery of the recording paper wound in a roll shape, and rotatably support the recording paper wound in a roll shape,
wherein at least one of the plurality of rollers is a movement regulation roller which regulates movement of the recording paper in a winding-off direction by winding-off of the recording paper wound in a roll shape in the recording paper storage section.

12. The electronic register according to claim 11, wherein the movement regulation roller is arranged closest to a side to which the recording paper wound in a roll shape is fed.

13. The electronic register according to claim 11, wherein the movement regulation roller is formed such that an outer diameter thereof is larger than an outer diameter of each of the plurality of rollers excluding the movement regulation roller.

14. The electronic register according to claim 11, wherein the movement regulation roller is formed such that a projection length of the movement regulation roller projecting into the recording paper storage section from the bottom portion of the recording paper storage section is larger than a projection length of each of the plurality of rollers other than the movement regulation roller which are projecting into the recording paper storage section from the bottom portion of the recording paper storage section.
